(19) United States
(12) Patent Application Publication
(10) Pub. No.: US 2017/0098198 A1
(43) Pub. Date: Apr. 6, 2017

(54) REFERENCE HOURS TRACKING FOR MACHINE MAINTENANCE

(71) Applicant: Caterpillar Inc., Peoria, IL (US)

(72) Inventor: Robert Gerald Bullock, Germantown Hills, IL (US)

(73) Assignee: CATERPILLAR INC., Peoria, IL (US)

(21) Appl. No.: 14/873,402

(22) Filed: Oct. 2, 2015

(51) Int. Cl. G06Q 10/00; G06Q 10/10

(52) U.S. Cl. CPC G06Q 10/20; G06Q 10/10

(57) ABSTRACT

A method of tracking machine maintenance includes tracking units of time with a service meter associated with the machine. Machine maintenance protocols may be performed based on tracking of units of time with the service meter. The accuracy of the service meter may be assessed, and the method includes creating a virtual reference hour meter associated with the machine in response to a service meter inaccuracy being assessed. Units of time may be tracked with the virtual reference hour meter. Machine maintenance protocols may be performed based on tracking of units of time with the virtual reference hour meter.

### TECHNICAL FIELD

The present disclosure is directed to tracking maintenance and, more particularly, is directed to reference hours tracking for machine maintenance.

### BACKGROUND

Machines, such as excavators, material handling machines, mining machines, haulage machine, and other machines associated with an industry such as mining, agriculture, forestry, etc., may require maintenance in order to perform efficiently and reliably. Often, machines are deployed and operated by an entity as a fleet of machines. Maintenance for machines in a fleet may be tracked in order to help ensure that proper maintenance occurs according to a suitable schedule. Machines in a fleet may require various types of maintenance, and performance of some types of maintenance may be recommended after a predetermined number of time units, e.g. hours, of machine operation. For example, a maintenance protocol for a machine engine, after a predetermined number of hours of machine operation, may specify that routine maintenance such as an oil and oil filter change be performed. As another example, a maintenance protocol may specify partial or total disassembly of the engine or other major machine components for service. Repeat performance of this type of maintenance may then be recommended at subsequent intervals.

It may become difficult to keep track of the various types of maintenance that should be performed on a fleet of machines, and it may become even more difficult as the number of machines in a fleet increases. A typical tracking component for maintenance to be performed on a machine may involve a service meter which measures the time that a machine is in service and operating. Maintenance may be based on service meter units (SMU) of the machine. However, it occasionally occurs that the service meter from which SMU are obtained ceases to be accurate, at least for some types of machine maintenance.

An inaccuracy in the service meter, and the SMU that it measures, may occur due to a number of circumstances. For example, the service meter itself may have become defective and replaced by a new, replacement service meter. When this occurs, the new service meter may read zero instead of accurately reflecting the number of hours that the machine has been in service and in actual operation. Other causes for a service meter inaccuracy may include the installation of new electronics where original electronics may have failed due to a power surge, for example. In other circumstances, an engine or other major component that relies heavily on SMU to ensure proper maintenance may have been replaced. In such a situation, the service meter reading may not accurately reflect when engine maintenance, or other major component maintenance, is due.

When the service meter becomes inaccurate, a discrepancy may occur in the number of SMU of a machine relative to tracking maintenance services for the machine. In the example where an electrical surge has destroyed the machine electronics and new electronics have been installed and the service meter now reads zero hours, certain maintenance should still be performed based on the reading that would have been derived from the now destroyed service meter. There is a need for an alternative way to track hours, or other units of time, for the performance of various maintenance protocols and/or services when the service meter of a machine becomes inaccurate.

One type of system for tracking information, including information relating to machine maintenance, for machines of a fleet is disclosed in Patent Application Publication No. 2004/0073468 A1 to Vyas et al. (the '468 publication). The '468 publication discloses a system that relies on a service meter to track hours of machine operation. A user of the system may access information regarding, for example, the current number of hours on the service meter and the number of service meter hours at which a particular type of maintenance may be needed for machines of a fleet.

Although the system of the '468 publication enables a user to track information, such as maintenance performance and maintenance recommendations based on machine service meter hours, it does not disclose an alternative for situations where the service meter may not accurately reflect the correct number of hours for a particular maintenance interval. The system of the '468 publication performs well as long as the machine service meter is accurate and correctly indicates the number of service meter units, but may not be adequate where a service meter or a major machine component has been replaced.

The system for reference hours tracking for machine maintenance of the present disclosure solves one or more of the problems set forth above and/or other problems of the prior art.

### SUMMARY

In one aspect, the present disclosure is directed to a method of tracking machine maintenance including tracking units of time with a service meter associated with the machine. The method may include performing machine maintenance protocols based on the tracking of units of time with the service meter. The method also may include assessing accuracy of the service meter. The method also may include, responsive to a service meter inaccuracy being assessed, creating a virtual reference hour meter associated with the machine. The method also may include tracking units of time with the virtual reference hour meter. The method also may include performing machine maintenance protocols based on the tracking of units of time with the virtual reference hour meter.

In another aspect, the present disclosure is directed to a system for on-line tracking of maintenance intervals for a fleet of machines via a web-based computer program with user interface. The system may include a service meter configured to measure time units of operation for each machine of the fleet of machines until machine maintenance is due. The system also may include a virtual reference hour meter configured to measure time units of operation for at least some of the machines of the fleet of machines until machine maintenance is due. The system also may include a maintenance landing page including a plurality of icons, each icon identifying an individual machine of the fleet of machines, the maintenance landing page including at least one additional icon for each machine indicating whether time units of operation for the machine are being measured by the service meter, the virtual reference hour meter, or both the service meter and the virtual reference hour meter.

In yet another aspect, the present disclosure is directed to a method of maintaining a machine and tracking machine maintenance. The method may include placing a machine into service, the machine including a service meter configured to measure hours of machine operation. The method also may include performing one or more first maintenance protocols for the machine based on an indication of a number of hours by the service meter. The method also may include creating a virtual reference hour meter for the machine. The method also may include performing one or more second maintenance protocols for the machine based on an indication of a number of hours by the virtual reference hour meter.

### BRIEF DESCRIPTION OF THE DRAWINGS

FIG. 1 is a diagrammatic illustration of a system for tracking machine maintenance;

FIG. 2 is a schematic illustration of a page display;

FIG. 3 is a schematic illustration of a farther page display;

FIG. 4 is a schematic illustration of a further page display;

FIG. 5 is a schematic illustration of a further page display;

FIG. 6 is a flow diagram of a method for tracking machine maintenance; and

FIG. 7 is a flow diagram of a method for tracking machine maintenance.

### DETAILED DESCRIPTION

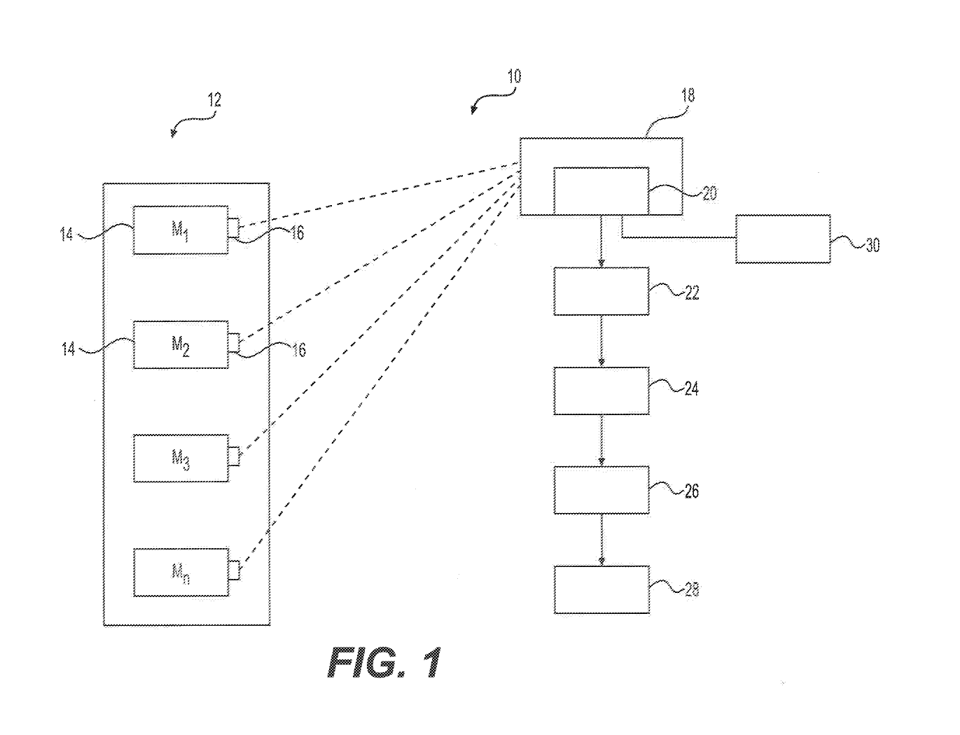

A system 10 for tracking machine maintenance is diagrammatically illustrated in FIG. 1. System 10 may be a system for on-line tracking of maintenance intervals for a fleet of machines via a web-based computer program with user interface. Often, an entity may own or otherwise be responsible for a fleet 12 of machines 14 which sometimes may include many machines. Fig. I illustrates diagrammatic representations of machines 14 labeled M₁, M₂, M₃, Mₙ, for example, which have been placed in service by an entity (e.g., a mining company, a construction company, etc.). Some of the machines 14 may be of the same type and others quite diverse. For example, a fleet 12 may include various excavators, dozers, loaders, haulage machines, etc.

In order to ensure effective and efficient operation of machines 14, certain maintenance protocols may be performed. For example, it may be recommended that a particular machine be removed from service temporarily for a maintenance protocol that involves certain routine maintenance procedures for the machine engine (e.g., oil change, compression test, etc.) after a predetermined number of hours in service. Some maintenance protocols may be relatively minor and/or involve only one procedure, while others may involve significant machine services and/or involve multiple procedures, such as machine overhauls (first overhaul, second overhaul, etc.). System 10 may be constructed to track machine maintenance and ensure that notice of recommended maintenance protocols may be timely given to appropriate personnel.

Each machine 14 may include a service meter 16 that is configured to measure the time that machine 14 is in operation. Service meter 16 may be configured to measure time units of operation for each machine of the fleet of machines until machine maintenance is due. Service meter 16 may conveniently measure hours, for example, but any unit of time is contemplated. When a machine 14 is first placed into service, service meter 16 may have a zero reading (e.g., service meter 16 may give a numerical indication of 0000 hours). As the service life of machine 14 proceeds, service meter 16 may give an accurate indication of the number of hours that machine 14 has been in operation since being placed in service. Service meter 16 thus may form a sound basis upon which to perform machine maintenance in accordance with the various recommended and/or required maintenance protocols. However, an event sometimes occurs that causes service meter 16 to be unreliable, at least for some machine maintenance protocols.

Tracking of machine maintenance may occur at one or more tracking locations 18. A tracking location 18 may be remotely located relative to a machine 14. In fact, the various machines 14 of fleet 12 may be in operation at a number of different locations. Machines 14 of the fleet 12 each may communicate with tracking locations 18. Communication between machines 14 and tracking locations 18 may be via any of various well-known forms of wired or wireless communication. For example, machines 14 may communicate with tracking locations 18 via satellite. Tracking locations 18 may be any place where a computer may access information via web-based on-line interface.

As described above, service meter 16 may record hours of machine operating time as machine operation proceeds. A user of the system, by accessing a maintenance tracking program 20 via a computer, may be able to determine from program 20 when a given maintenance protocol may be coming due. Maintenance protocols may be variously designated. For example, designations such as PM1, PM2, PM3, etc., may be used. If a maintenance protocol designated PM1 is recommended for a given machine 14 at 200 hours service time (i.e., 200 service meter units, or SMU), a system user may be able to determine, based on a reading of the SMU from tracking location 18, approximately when the recommended service protocol should occur. In this way, notification may be given to appropriate personnel and all service protocols for each machine 14 of fleet 12 may be performed in a timely manner.

Program 20 may include a number of display screens or pages. For example, four pages (22, 24, 26, 28) are diagrammatically illustrated in FIG. 1. However, the number of pages may vary depending on information that a user may desire to retrieve or the entries a user may desire to make relative to machines 14 and fleet 12. In an example, an initial page may be designated maintenance landing page 22. Maintenance landing page 22, for example, may effectively be the “home page” for retrieving information relative to maintenance of machines 14 of fleet 12. In this example, subsequent pages (to be described subsequently) may be accessible via links from maintenance landing page 22 or from other pages, and may permit retrieving of additional information relative to maintenance of machine 14 of fleet 12 and/or permit a user to make changes, add information, etc. For example, one or more of the subsequent or additional pages may include suitable icons and/or links configured to permit a user to establish a virtual reference hour meter 30 for tracking maintenance protocols and intervals between maintenance events (i.e., maintenance intervals). A virtual reference hour meter 30 may be configured, for at least some of the machines 14 of a fleet 12, to measure time units of operation until machine maintenance is due. Virtual reference hour meter 30 may be established, e.g., configured and enabled, when a service meter 16 of a machine 14 has become inaccurate.

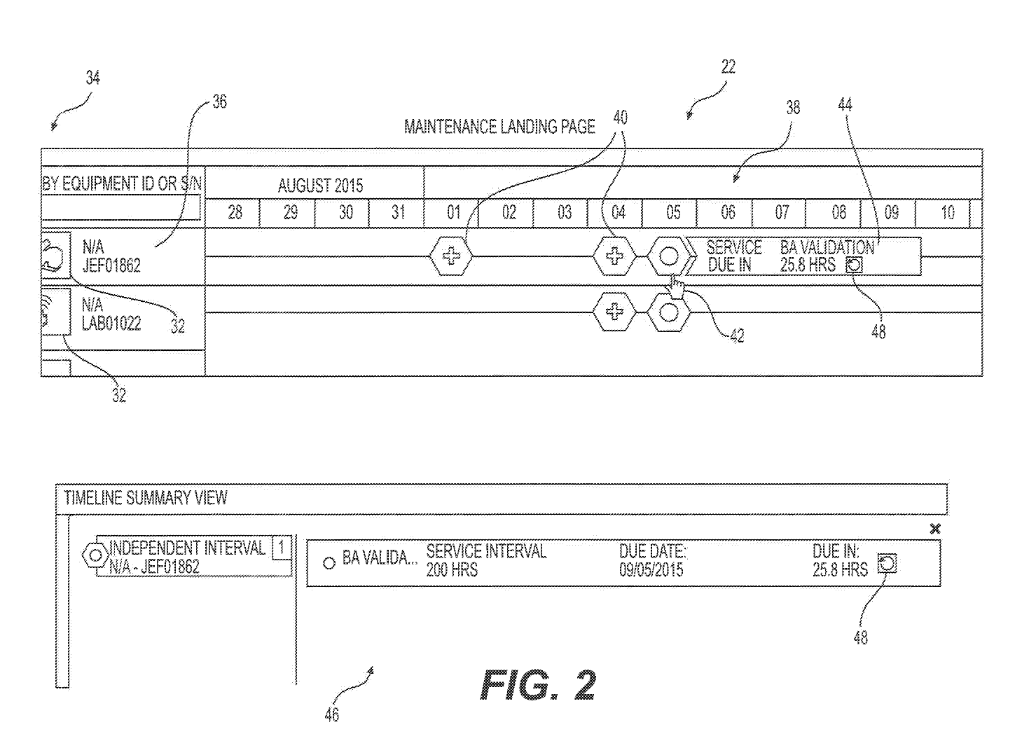

FIG. 2 is a schematic diagram representing an exemplary maintenance landing page 22 for program 20, which may be an on-line, web-based program. Maintenance landing page 22 may include a plurality of icons or hyperlinks, with each icon or hyperlink identifying an individual machine of the fleet 12. Maintenance landing page 22 also may include at least one additional icon for each machine 14 indicating whether time units of operation for machine 14 are being measured by service meter 16, virtual reference hour meter 30, or both service meter 16 and virtual reference hour meter 30. For example, machines 14 may be represented by icons 32 displayed as images of the machines 14. Machines 14 may be listed in a vertical column 34 that may appear at the left-hand side of maintenance landing page 22, for example. Icons 32 may be accompanied by identifying information such as, for example, an equipment identification number 36, which may be a hyperlink if desired. Alternative or additional identifying information also may appear adjacent icons 32.

Certain maintenance information for machines 14 may be accessed by a user on maintenance landing page 22. For example, projected due dates for various maintenance protocols may be identified via maintenance landing page 22. To that end, maintenance landing page 22 may be provided with a horizontal sequential date listing 38 across its upper portion, for example, representing a time span. The date listing 38 may begin at a predetermined date prior to the current date maintenance landing page 22 is accessed, and span to a predetermined date subsequent to that date, for example. Alongside each machine icon 32, and within the time span displayed across maintenance landing page 22, icons 40 representing maintenance protocols may be displayed under the horizontally listed dates. A user may hover pointer 42 over an icon 40 under a listed date. This may provide a hover-over display 44 that includes information giving an indication of an upcoming maintenance protocol. Based on current service time, as indicated by a service meter 16 of a particular machine, maintenance landing page 22, via hover-over display 44, for example, may indicate the number of hours until maintenance is due, and the projected date (predicted based on current machine usage) that the maintenance should be performed,

Maintenance landing page 22 also may permit a user to access details related to the scheduled maintenance. For example, a user may, via pointer 42, select an icon 40. This may activate a pop-up display 46 giving specifics of the particular upcoming maintenance protocol. Pop-up display 46 may include information such as the number of hours between service intervals for the maintenance protocol, the projected due date for the next interval, and whether tracking for that particular protocol is via service meter 16 or via a virtual reference hour meter 30 (FIG. 1). In the example of FIG. 2, icon 48, appearing both in the hover-over display 44 and in pop-up display 46, indicates that a virtual reference hour meter 30 is tracking the maintenance protocol.

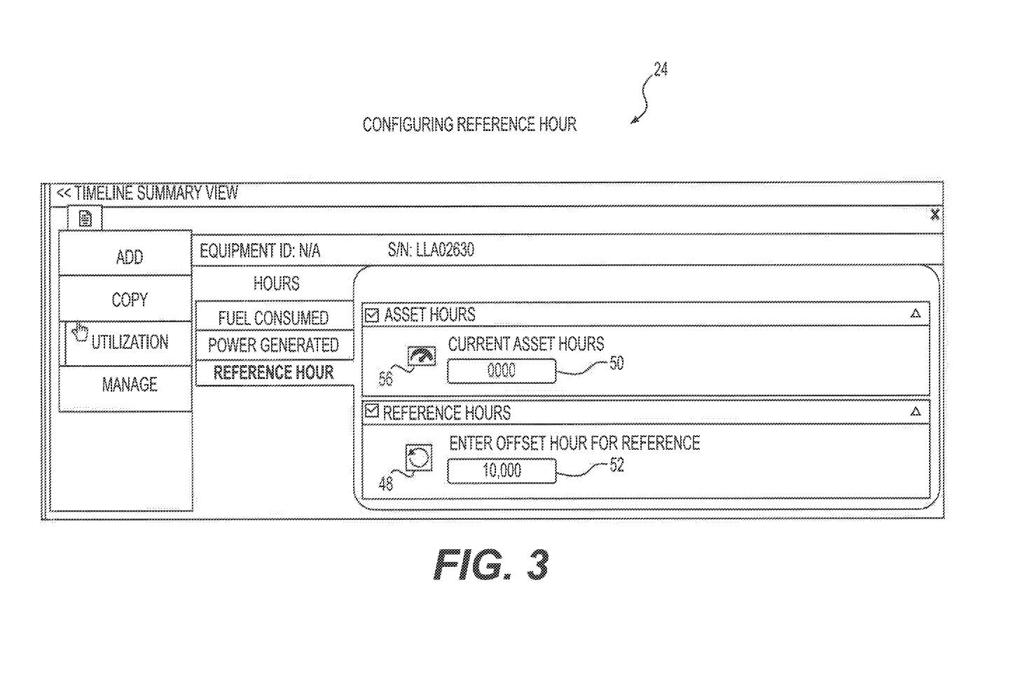

As disclosed herein, a particular machine 14 may have a service meter 16 that is not accurate for some or all maintenance protocols that are recommended/required for that machine. For example, a new service meter 16 may have been installed, and the reading for the new service meter may be zero (e.g., 0000). In such a situation, a user may access a further page included in program 20 in order to establish a virtual reference hour meter 30. Referring to FIG. 3, the further page included may be a page 24 permitting configuration of a virtual reference hour meter 30 for an individual machine 14 of fleet 12. Configuring reference hour page 24 may be accessed by a user from maintenance landing page 22 by selecting icon 32 representing the affected machine 14. It will be understood that configuring reference hour page 24 could be accessed otherwise, for example from other program pages and/or other programs via various hyperlinks and/or icons.

Configuring reference hour page 24 may permit a user to select virtual reference hour tracking for the selected machine 14. Configuring reference hour page 24 may display the current service meter reading 50 (illustrated here as 0000) and may provide an entry line 52 for the user to enter a number of offset hours for a virtual reference hour meter 30 for the selected machine 14. For example, where a new service meter 16 has been installed, but the actual service time of machine 14 is 10,000 hours, the figure “10,000” may be entered in entry line 52. This may provide an offset hour reading that accurately indicates actual service time and that may be used for accurately tracking certain machine maintenance protocols and determining service intervals.

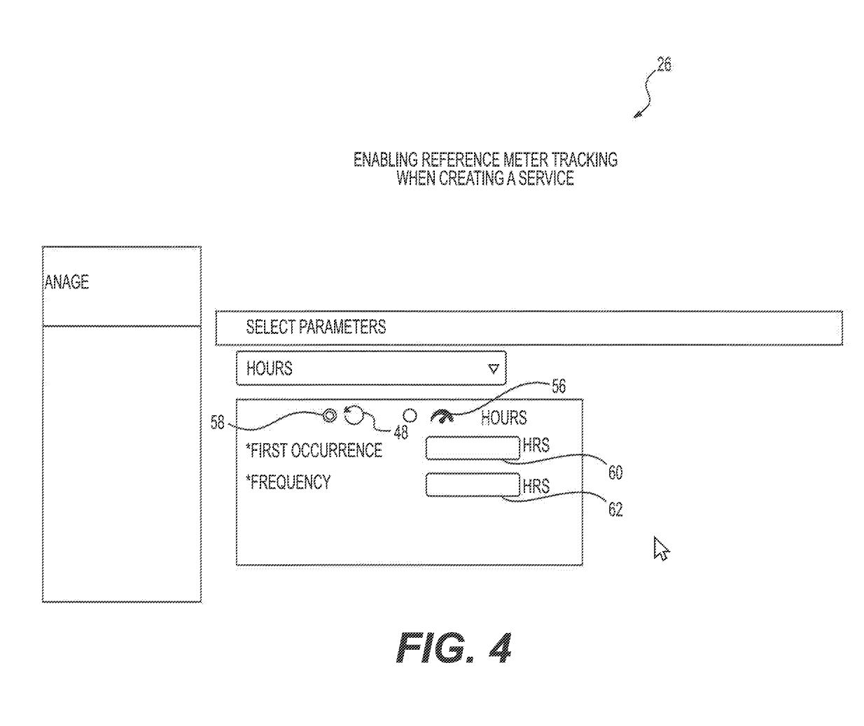

Configuring reference hour page 24 may provide a link permitting a user to access a further page included in program 20 in order to create a new maintenance protocol or enable virtual reference hour meter tracking for a particular existing maintenance protocol. Alternatively, a link may be provided on maintenance landing page 22 permitting a user to access the further page. The included further page may be a page 26 permitting enabling virtual reference hour meter 30 for the individual machine 14 of fleet 12. Page 26 also may be configured for creating a maintenance interval and permitting virtual reference hour meter tracking to be enabled for the created maintenance interval. Page 26 is schematically illustrated in FIG. 4. Enabling reference meter tracking page 26 may provide a user with the ability to select whether to enable virtual reference hour meter tracking, indicated by icon 48, or track with a service meter 16, indicated by icon 56. It will be understood that icons 48 and 56 are illustrative, and that various images, symbols, etc., may be used to represent service meters and virtual reference hour meters.

In FIG. 4, selection button 58 has been activated via a mouse pointer 42 (FIG. 2), for example. This indicates that virtual reference hour meter tracking has been selected for the particular maintenance protocol. An entry line 60 may be included for the number of machine service hours at which the first occurrence of the affected maintenance protocol may occur. An entry line 62 also may be included for the frequency at which the affected maintenance protocol should occur. The frequency indication on entry line 62 may establish the interval, for example 200 hours, 400 hours, etc., for performance of the maintenance protocol.

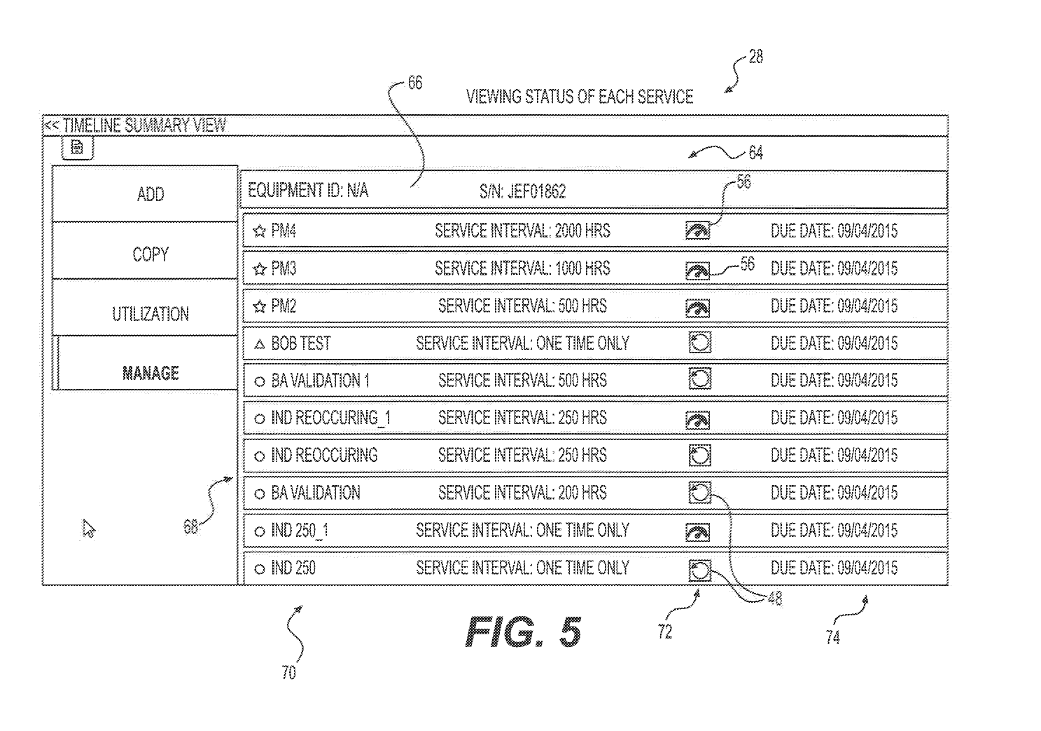

FIG. 5 illustrates a status page 28 that may be accessed via a suitable link from one or more other program pages. Status page 28 may be a page for viewing the status indication of each maintenance interval for a machine 14, with at least one of service meter icon 56 and virtual reference hour meter icon 48 displayed near and associated with each status indication. From status page 28, a user may, among other things, view each maintenance protocol for the machine 14 that has been selected. For example, status page 28 may include a table 64 identifying the machine 14 and listing the various maintenance protocols, each of which may include replacement of one or more parts, change of fluids, tests, etc. For example, line 66 may include identifying information for the selected machine 14. The maintenance protocols for machine 14 may be listed vertically and identified in a column 68. Another column 70 may indicate the frequency or service interval for the maintenance protocol in column 68.

Where an event has occurred that has caused the machine service meter 16 to be inaccurate for a maintenance protocol, a virtual reference hour meter may have been created/configured for machine 14 and may have been enabled for certain (either some or all) maintenance protocols. An additional column 72 of table 64 may include information indicating whether the maintenance protocol entry is being tracked via the machine service meter 16, or via a virtual reference hour meter 30. In FIG. 5, it can been seen that some of the maintenance protocols indicated in column 68 are being tracked via the machine service meter 16 (as indicated by icons 56), and others of the maintenance protocols indicated in column 68 are being tracked via a virtual reference hour meter 30 (as indicated by icons 48). A further column 74 in table 64 may give an indication of the due date for the maintenance protocol on a given line of table 64. Selecting and/or hovering over the service meter icon 56 or virtual reference hour meter icon 48 may enable a user to view the specific meter reading in hours, for example.

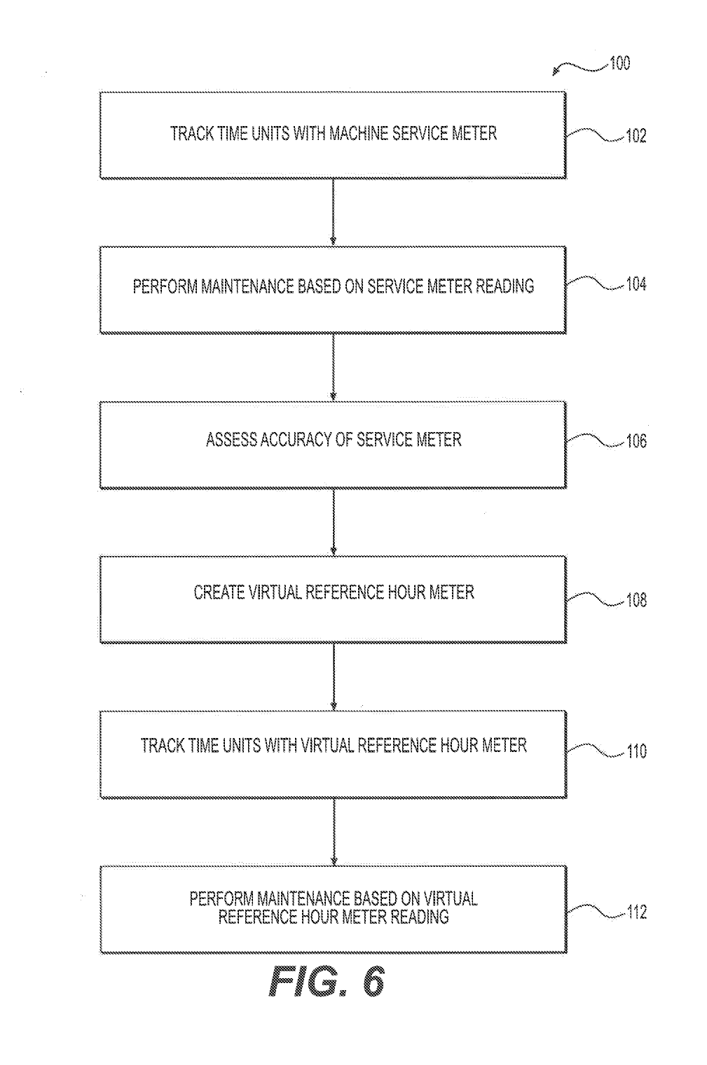

FIG. 6 is a flow diagram illustrating an exemplary method for tracking machine maintenance at 100. In ordinary circumstances, a machine 14 may include a service meter 16 (FIG. 1) that may indicate the number of hours machine 14 has been operating since being placed in service. At step 102, units of time, e.g., hours, may be tracked by service meter 16 associated with machine 14. After a predetermined number of service hours, a machine may be scheduled for various maintenance protocols, and scheduling may be based on an SMU reading from service meter 16. For example, a reading from service meter 1.6 may indicate that various ones of maintenance protocols designated PM1, PM2, PM3, etc., may be due.

At step 104, machine maintenance may be performed based on readings from the service meter. When one or more maintenance protocols has/have been indicated due based on the service meter reading, machine 14 may be removed from service and the indicated maintenance may be performed.

At some point during the service life of a machine 14, an event may occur that renders service meter 16 inaccurate for at least some maintenance protocols. For example, service meter 16 itself may become defective. As another example, the electronics of machine 14 may have been damaged by a power surge and new electronics may have been installed, in which case service meter 16 may then read zero (e.g., 0000). Other events, such as replacement of the engine or another major component of machine 14, may occur and render service meter 16 inaccurate relative to maintenance to the engine or other major component. On the occurrence of such an event, an assessment must be made relative to the accuracy of service meter 16 at step 106. Where service meter 16 has been destroyed by a power surge, for example, and a new service meter has been installed in machine 14, it can be concluded that the new service meter is inaccurate at least for some maintenance items.

Once it has been determined that service meter 16 of machine 14 may be inaccurate, a virtual reference hour meter 30 may be created, at step 108, for example with a maintenance tracking program 20. As described, machine maintenance ordinarily is tracked by a maintenance tracking program 20, and tracking is based on service meter readings. However, when service meter 16 no longer displays the correct number of hours for intervals between performance of maintenance protocols, a user of the program will be unable to determine when the various maintenance protocols are due. Creation of virtual reference hour meter 30 provides for alternative tracking. For example, where machine electronics have been replaced and the service meter reads zero, virtual reference hour meter 30 may be set to indicate the actual number of machine service hours based on the last reading from the service meter 16 that was replaced.

Once virtual reference hour meter 30 has been created, machine maintenance may be tracked with the newly created virtual reference hour meter 30, at step 110. It still may be desirable to track some maintenance protocols based on the replacement service meter 16, while other maintenance protocols may be tracked based on virtual reference hour meter 30. During the subsequent service life of machine 14, maintenance may be performed, at least for some maintenance protocols, based on tracking units of time with virtual reference hour meter 30, at step 112.

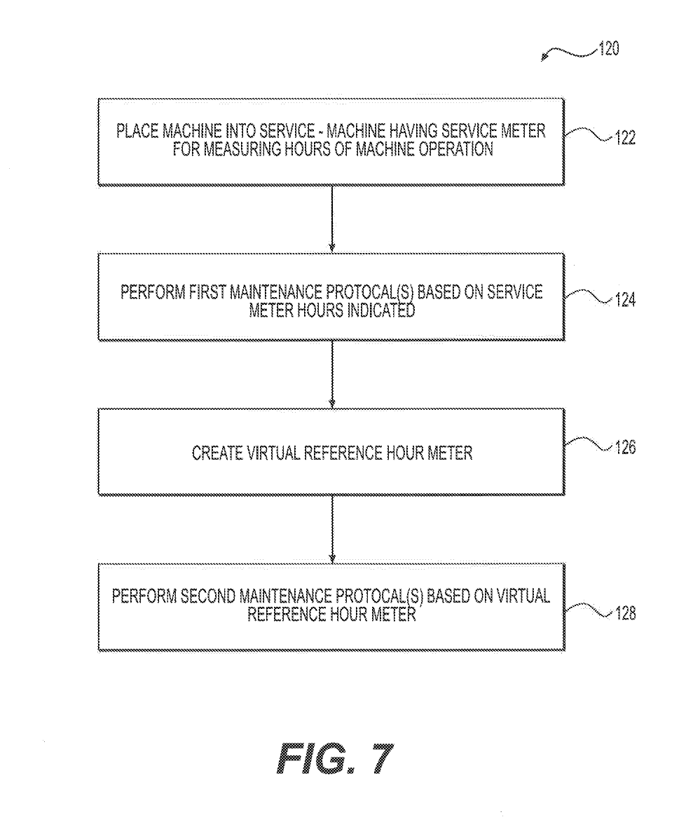

FIG. 7 is a flow diagram illustrating, an exemplary method of maintaining a machine and tracking machine maintenance at 120. A machine 14 may be placed into service at step 122, for example by an entity such as a construction or mining company. Machine 14 may include a service meter 16 configured to measure hours of machine operation. As machine 14 continues in service and after a predetermined number of hours of operation have occurred, service meter 16 may indicate a number of hours corresponding to a recommended or required maintenance protocol to be performed on machine 14. Notification of the upcoming maintenance may be acquired via maintenance tracking program 20 of system 10.

When a first maintenance protocol(s) become due, appropriate personnel may perform one or more first maintenance protocols for machine 14 based on an indication of a number of hours by service meter 16. Referring back to FIG. 5, this may include any one or more of the maintenance protocols listed in column 68 of table 64, and may include other maintenance items not specifically indicated. Once first maintenance protocol(s) has/have been performed, machine 14 may be placed back into operation.

At some point during the service life of machine 14, service meter 16 may become inaccurate with respect to one or more maintenance protocols. A typical example, previously described, may be that electronics on machine 14 may have become damaged by a power surge, and new electronics may have been installed, resulting in a service meter with a zero reading (e.g., 0000). Via maintenance tracking program 20, for example, a user may create a virtual reference hour meter 30, at step 126, for example by configuring it (see FIG. 3 and the accompanying description above) and then enabling it for maintenance protocol(s) that require tracking based on the hours of machine operation since it was placed in service (see FIG. 4 and the accompanying description above).

As machine operation proceeds and maintenance is tracked via maintenance tracking program 20, a user may access maintenance landing page 22 (FIG. 2) and determine which maintenance protocols may have become due and the date and/or number of machine operation hours before they should be performed. An indication may be given whether tracking of the upcoming maintenance protocols are based on the created virtual reference hour meter 30, or based on service meter 16. When the indicated time becomes due, second maintenance protocol(s) may be performed, at step 128, based on the hours indicated on virtual reference hour meter 30.

### INDUSTRIAL APPLICABILITY

The disclosed system and method for reference hours tracking for machine maintenance may be useful in those situations where, for example, a service meter has been replaced in a machine, new electronics have been installed, and/or where an engine or other major machine component has been replaced. The method and system may permit a user to create, i.e., configure and enable, a virtual reference hour meter to accurately display the correct number of time units, e.g., hours, for a particular type of machine maintenance when a machine service meter has become inaccurate.

The method may include accessing an on-line web-based program for tracking machine maintenance, selecting a link representing the machine, e.g., from a list including machines in a fleet of machines, selecting a link for enabling configuring of a virtual reference hour meter for the machine, and setting the virtual reference hour meter to a desired number of hours. The desired number of hours may be indicative of the actual time that the machine has been in operation. The method also may include selecting a link for creating a maintenance protocol, creating a new maintenance protocol, and selecting whether the new maintenance protocol is to be tracked via the machine service meter or via the virtual reference hour meter. Service meter readings indicating the number of hours may be accessed from a plurality of locations, and the virtual reference hour meter may be accessed from the same plurality of locations.

Service meter units may be tracked via the maintenance tracking program, and where the service meter becomes inaccurate, the virtual reference hour meter may provide a way to ensure that the machine is properly maintained. Maintenance tracking program 20 may provide screen displays or pages with suitable links to enable a user to create a virtual reference hour meter, determine which maintenance protocols are being tracked by the created virtual reference hour meter, and keep track of when the various maintenance protocols should be performed. The service meter may still be suitable for tracking certain maintenance items, but the virtual reference hour meter may provide a useful and straightforward alternative where the service meter is not appropriate for tracking.

Notably, maintenance tracking program 20, as an on-line, web-based tracking system, enables a user to access it via either fixed tracking stations 18, or via easily mobile tracking stations 18 (e.g., via portable laptop computer). When a virtual reference hour meter 30 is enabled, all locations where machine SMU are displayed also will display the virtual reference hour meter.

Where service meter inaccuracy has occurred as a result of a defective service meter associated with a machine, the defective service meter may be replaced with a new service meter, and a created virtual reference hour meter may be set at a reading of units of time indicative of the actual time that the machine has been in operation while in service. Where service meter inaccuracy has occurred as a result of failure of one or more components in an electronic system of the machine, e.g., an electronic control module, the one or more components may be replaced, and a created virtual reference hour meter may be set at a reading of units of time indicative of the actual time that the machine has been in operation. Where the service meter inaccuracy has occurred as a result of replacement of a major machine component, a replacement major machine component may be installed, and a created virtual reference hour meter may be set at a reading of units of operating time indicative of the operating time of the replacement major machine component, i.e., zero (0000).

It will be apparent to those skilled in the art that various modifications and variations can be made in the disclosed system and method for reference hours tracking for machine maintenance without departing from the scope of the disclosure. Other embodiments of the disclosed system and method for reference hours tracking for machine maintenance will be apparent to those skilled in the art from consideration of the specification. It is intended that the specification and examples be considered as exemplary only, with a true scope of the disclosure being indicated by the following claims and their equivalents.

What is claimed is:

1. A method of tracking machine maintenance, comprising:
tracking units of time with a service meter associated with the machine;
performing machine maintenance protocols based on the tracking, of units of time with the service meter;
assessing accuracy of the service meter;
responsive to a service meter inaccuracy being assessed, creating a virtual reference hour meter associated with the machine;
tracking units of time with the virtual reference hour meter; and
performing machine maintenance protocols based on the tracking of units of time with the virtual reference hour meter.

2. The method of claim 1, wherein the service meter inaccuracy has occurred as a result of a defective service meter associated with the machine, and further including:
replacing the defective service meter with a new service meter; and
setting the created virtual reference hour meter at a reading of units of time indicative of the actual time that the machine has been in operation.

3. The method of claim 1, wherein the service meter inaccuracy has occurred as a result of failure of one or more components in an electronic system of the machine, and further including:
replacing the failed one or more components; and
setting the created virtual reference hour meter at a reading of units of time indicative of the actual time that the machine has been in operation.

4. The method of claim 3, wherein the one or more components in the electronic system of the machine includes an electronic control module.

5. The method of claim 1, wherein the service meter inaccuracy has occurred as a result of replacement of a major machine component, and further including:
installing a replacement major machine component; and
setting the created virtual reference hour meter at a reading of units of operating time indicative of the operating time of the replacement major machine component.

6. The method of claim 5, wherein the created virtual reference hour meter is set at a reading of zero.

7. The method of claim 1, wherein creating the virtual reference hour meter includes:
accessing an on-line web-based program for tracking machine maintenance;
selecting a link representing the machine;
selecting a link for enabling configuring of a virtual reference hour meter for the machine; and
setting the virtual reference hour meter to a desired number of hours.

8. The method of claim 7, wherein the desired number of hours is indicative of the actual time that the machine has been in operation.

9. The method of claim 1, wherein service meter readings may be accessed from a plurality of locations, and the virtual reference hour meter may be accessed from the same plurality of locations.

10. A system for on-line tracking of maintenance intervals for a fleet of machines via a web-based computer program with user interface, comprising:
a service meter configured to measure time units of operation for each machine of the fleet of machines until machine maintenance is due;
a virtual reference hour meter configured to measure time units of operation for at least some of the machines of the fleet of machines until machine maintenance is due; and
a maintenance landing page including a plurality of icons, each icon identifying an individual machine of the fleet of machines, the maintenance landing page including at least one additional icon for each machine indicating whether time units of operation for the machine are being measured by the service meter, the virtual reference hour meter, or both the service meter and the virtual reference hour meter.

11. The system of claim 10, further including a page permitting configuration of a virtual reference hour meter for an individual machine of the fleet of machines.

12. The system of claim 11, further including a page permitting enabling the virtual reference hour meter for the individual machine of the fleet of machines.

13. The system of claim 10, including both a service meter icon and a virtual reference hour meter icon, and including a page for viewing the status indication of each maintenance interval for a machine, wherein at least one of the service meter icon and the virtual reference hour meter icon is displayed near and associated with each status indication.

14. The system of claim 10, including a page for creating a maintenance interval and permitting virtual reference hour meter tracking to be enabled.

15. A method of maintaining a machine and tracking machine maintenance, comprising:
placing a machine into service, the machine including a service meter configured to measure hours of machine operation;
performing one or more first maintenance protocols for the machine based on an indication of a number of hours by the service meter;
creating a virtual reference hour meter for the machine; and
performing one or more second maintenance protocols for the machine based on an indication of a number of hours by the virtual reference hour meter.

16. The method of claim 15, wherein the indication of a number of hours by the service meter may be accessed from multiple locations, and the indication of a number of hours by the virtual reference hour meter may be accessed from the same multiple locations.

17. The method of claim 15, further including:
replacing the service meter by providing a replacement service meter indicating zero hours when provided; and
setting the virtual reference hour meter to indicate the actual number of hours that the machine has been placed in service.

18. The method of claim 15, wherein creating a virtual reference hour meter for the machine includes:
accessing an on-line web-based program for tracking machine maintenance;
selecting a link representing the machine from a listing representing machines of a fleet of machines;
selecting a link for the machine for enabling configuring of a virtual reference hour meter; and
setting the virtual reference hour meter to a desired number of hours.

19. The method of claim 18, further including replacing the service meter by providing a replacement service meter indicating zero hours when provided, and wherein setting the virtual reference hour meter to a desired number of hours includes setting the virtual reference hour meter to indicate the actual number of hours that the machine has been placed in service.

20. The method of claim 18, including:
selecting a link for creating a maintenance protocol;
creating a new maintenance protocol; and
selecting whether the new maintenance protocol is to be tracked via the machine service meter or via the virtual reference hour meter.
